(19) United States
(12) Patent Application Publication
(10) Pub. No.: US 2009/0188578 A1
(43) Pub. Date: Jul. 30, 2009

(54) MULTILAYER TUBE BASED ON A POLYAMIDE AND A FLUOROPOLYMER FOR TRANSFERRING FLUIDS

(75) Inventors: Anthony Bonnet, Beaumont Le Roger (FR); Nicolas Amouroux, Valailles (FR); Gaelle Bellet, Evreux (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Puteaux (FR)

(21) Appl. No.: 11/577,559

(22) PCT Filed: Oct. 18, 2005
(86) PCT No.: PCT/EP05/11794

§ 371 Date: Apr. 19, 2007

Related U.S. Application Data
(60) Provisional application No. 60/647,144, filed on Jan. 26, 2005.

(30) Foreign Application Priority Data
Oct. 19, 2004 (FR) 0411071
Oct. 20, 2004 (FR) 0411187
Oct. 29, 2004 (FR) 0411570

(51) Int. Cl. F16L 11/04; F16L 11/20

(52) U.S. Cl. 138/137; 138/141; 428/36.91

(57) ABSTRACT

The present invention relates to a multilayer tube comprising, in its radial direction from the outside inwards: a polyamide outer layer (1); an inner layer (2) of a composition comprising, the total being 100%, 5 to 30% by weight of a blend (A) comprising: a polyethylene carrying epoxy functional groups, an impact modifier chosen from elastomers and very low-density polyethylenes, the said impact modifier being completely or partly functionalized; 95 to 70% by weight of a blend (B) comprising: a fluoropolymer (B1), a functionalized fluoropolymer (B2), the proportion of (B2) being between 1 and 80% by weight of (A)+(B), the layers being successive and adhering to one another in their respective contact region. The inner layer is the layer in contact with the fluid being transported. The layer (2) may be conductive. It is also possible to place a polyamide layer (3) beside the layer (2), which layer becomes the inner layer. The tube of the present invention has a very low permeability to petrol, particularly to hydrocarbons and to their additives, in particular alcohols such as methanol and ethanol, or even ethers such as MTBE or ITBE. These tubes also exhibit good resistance to fuels and to lubricating oils for engines. This tube exhibits very good mechanical properties at low temperature and at high temperature. The invention also relates to the use of these tubes for transporting petrol.

The present invention relates to a multilayer tube based on a polyamide and a fluoropolymer for transferring fluids.

As examples of tubes for transferring fluids, mention may be made of petrol pipes, in particular for carrying petrol from the tank to the engine of motor vehicles. As other examples of fluid transfer, mention may be made of the fluids used in fuel cells, CO₂ systems for cooling, hydraulic systems, cooling circuits and air-conditioning circuits, and medium-pressure power transfer.

For safety and environmental protection reasons, motor-vehicle manufacturers require these tubes to have not only mechanical properties such as burst strength and flexibility with good cold (−40° C.) impact strength and high-temperature (125° C.) strength, but also a very low permeability to hydrocarbons and to their additives, particularly alcohols such as methanol and ethanol. These tubes must also have good resistance to the fuels and lubrication oils for engines. These tubes are manufactured by coextruding the various layers using standard techniques for thermoplastics.

The invention is particularly useful for transporting petrol.

The content of french appln 04-11187 filed on 20 Oct. 2004, french appln 04-11570 filed on 29 Oct. 2004, french appln 04-11071 filed on 19 Oct. 2004 and U.S. provisional specification 60/647,144 filed on 26 Jan. 2005 are incorporated in the present application.

### PRIOR ART AND THE TECHNICAL PROBLEMS

Among the characteristics of the specification for tubes carrying petrol, five are particularly difficult to achieve simultaneously in a simple manner:
cold (−40° C.) impact strength, the tube not breaking;
fuel resistance;
high-temperature (125° C.) resistance;
very low permeability to petrol;
good dimensional stability of the tube when used for petrol.

In the multilayer tubes of various structures, the cold impact strength remains unpredictable before the standardized cold impact strength tests have been carried out.

Patent EP 558 373 discloses a tube for transporting petrol, which respectively comprises a polyamide outer layer, a tie layer and an inner layer in contact with the petrol and consisting of a fluoropolymer. The petrol permeability is excellent but the shock resistance is insufficient.

Patents EP 696 301, EP 740 754 and EP 726 926 disclose tubes for transporting petrol, which comprise respectively a polyamide outer layer, a tie layer, a PVDF (polyvinylidene fluoride) layer, a tie layer and a polyamide inner layer in contact with the petrol.

Other polyamide/PVDF-based tubes for transporting petrol are disclosed in U.S. Pat. No. 5,472,784, U.S. Pat. No. 5,474,822, U.S. Pat. No. 5,500,263, U.S. Pat. No. 5,510,160, U.S. Pat. No. 5,512,342 and U.S. Pat. No. 5,554,426.

In these tubes of the prior art, complicated compositions have been described for ensuring adhesion between the polyamide and the PVDF.

Patent EP 1 104 526 discloses a tube having, along its radial direction from the inside outwards, an inner layer, based on a fluororesin (or fluoropolymer) and intended to come into contact with a flowing fluid, characterized in that the inner layer is formed from a blend comprising a semicrystalline thermoplastic fluororesin (for example PVDF) and an ABC triblock copolymer, the three blocks A, B and C being linked together in this order, each block being either a homopolymer or a copolymer obtained from two or more monomers, block A being connected to block B and block B being connected to block C by means of a covalent bond or by an intermediate molecule linked to one of these blocks via a covalent bond or to the other block via another covalent bond, and in that:

block A is compatible with the fluororesin;

block B is incompatible with the fluororesin and is incompatible with block A;

block C is incompatible with the fluororesin, block A and block B;

the outer layer of the tube being made of a polyamide. This PVDF-based layer is impact-resistant while still remaining a barrier to petrol. However, adhesion to the polyamide layer remains to be provided.

A fluoropolymer-based composition has now been found that is particularly impermeable and impact-resistant and is able to adhere directly to substrates, such as a polyamide substrate. The present composition exhibits excellent solvent resistance, for example to solvents such as alcohol-based fuels, and very low permeability.

### BRIEF DESCRIPTION OF THE INVENTION

The present invention relates to a multilayer tube comprising, in its radial direction from the outside inwards:

a polyamide outer layer (1);
an inner layer (2) of a composition comprising, the total being 100:
5 to 30% by weight of a blend (A) comprising:
a polyethylene carrying epoxy functional groups,
an impact modifier chosen from elastomers and very low-density polyethylenes, the said impact modifier being completely or partly functionalized;
   95 to 70% by weight of a blend (B) comprising:
a fluoropolymer (B1),
a functionalized fluoropolymer (B2),
the proportion of (B2) being between 1 and 80% (advantageously between 1 and 60%) by weight of (A)+(B), the layers being successive and adhering to one another in their respective contact region. The inner layer is the layer in contact with the transported fluid.

According to one embodiment of the invention, the inner layer (2) contains an electrically conductive material, producing a surface resistivity of preferably less than 10⁶Ω.

According to another embodiment of the invention, the inner layer (2) contains essentially no electrically conductive material and the tube comprises a layer (2a) placed beside the layer (2), which layer (2a), like the layer (2), may be based on (A) and (B) but also contains an electrically conductive material producing a surface resistivity of preferably less than 10⁶Ω. This layer (2a) may also be a fluoropolymer (B1) or a blend of a fluoropolymer (B1) and an impact modifier and contains, in addition, an electrically conductive material producing a surface resistivity of preferably less than 10⁶Ω. The inner layer (2a) is the layer in contact with the transported fluid.

One advantage of these structures is that the layer in contact with the transported fluid (for example petrol for motor vehicles) contains no or very few substances (for example oligomers or plasticizers) that can pass into the petrol. To quantify this property, an extraction fluid (for example methanol or ethanol or even octane) is made to circulate in a closed circuit in the tube at temperatures of about 40 or 60° C. How much of the extraction fluid is picked up by the tube is then measured and this measurement is repeated for several hours in succession until a stable value is obtained. This measurement may also be carried out by immersing the material of the inner layer, in the form of granules, into the extraction fluid and stirring it. The inner layer is considered to be clean if the extraction fluid picks up no more than 5%, advantageously 4% and preferably 3%, by weight of products extracted from the inner layer.

Another embodiment relates to a multilayer tube comprising, in its radial direction from the outside inwards:

a polyamide outer layer (1);

a layer (2) of a composition comprising, the total being 100%, 0 to 30% by weight of a blend (A) comprising:
a polyethylene carrying epoxy functional groups,
an impact modifier chosen from elastomers and very low-density polyethylenes, the said impact modifier being completely or partly functionalized;

100 to 70% by weight of a blend (B) comprising:
optionally, a fluoropolymer (B1),
a functionalized fluoropolymer (B2),
the proportion of (B2) being between 10 and 100%, advantageously 30 to 90% and preferably 40 to 75%, by weight of (A)+(B);

a polyamide inner layer (3);

the layers being successive and adhering to each other in their respective contact region. The inner layer is in contact with the transported fluid.

According to one embodiment of the invention, the inner layer (3) contains an electrically conductive material producing a surface resistivity of preferably less than 10⁶Ω.

According to another embodiment of the invention, the inner layer (3) contains essentially no electrically conductive material and the tube comprises a layer (3a) placed beside the layer (3), which layer (3a) is made of a polyamide but contains, in addition, an electrically conductive material producing a surface resistivity of preferably less than 10⁶Ω. Advantageously, the polyamide of the layer (3a) is the same as that of the layer (3).

According to one advantageous embodiment, the polyamide of the outer layer (1) is a polyamide having amine terminal groups or comprising more amine terminal groups than acid terminal groups.

According to one advantageous embodiment, a layer of a polyamide having amine terminal groups or one comprising more amine terminal groups than acid terminal groups is placed between the outer layer (1) and the layer (2).

According to another embodiment, these two preceding embodiments may be combined.

These tubes may have an outside diameter of 6 to 110 mm and a thickness of around 0.5 to 5 mm.

Advantageously, the petrol tube according to the invention has an outside diameter ranging from 6 to 12 mm and a total thickness of 0.22 mm to 2.5 mm. In the tubes having an inner layer (2) or (2a), the thickness of the outer layer (1) represents between 30 and 95% of the thickness of the tube. In the tubes having an inner layer (3) or (3a), the thickness of the outer layer (1) represents between 25 and 50% of the thickness of the tube.

The tube of the present invention has a very low permeability to petrol, especially to hydrocarbons and to their additives, in particular alcohols like methanol and ethanol, or even ethers such as MTBE or ETBE. These tubes also have good resistance to fuels and to lubricating oils for engines.

This tube exhibits very good mechanical properties at low temperature and at high temperature.

The invention also relates to the use of these tubes for transporting petrol.

### DETAILED DESCRIPTION OF THE INVENTION

The tubes having a fluoropolymer-based inner layer (2) or (2a) will firstly be described.

With regard to the polyamide of the outer layer (1), mention may be made of PA-11 and PA-12.

Mention may also be made of those of formula X, Y/Z or 6, Y2/Z in which:

X denotes the residues of an aliphatic diamine having from 6 to 10 carbon atoms;

Y denotes the residues of an aliphatic dicarboxylic acid having from 10 to 14 carbon atoms;

Y2 denotes the residues of an aliphatic dicarboxylic acid having from 15 to 20 carbon atoms; and

Z denotes at least one unit chosen from the residues of a lactam, the residues of an alpha, omega-aminocarboxylic acid, the unit X1,Y1 in which X1 denotes the residues of an aliphatic diamine and Y1 denotes the residues of an aliphatic dicarboxylic acid,

the weight ratios Z/(X+Y+Z) and Z/(6+Y2+Z) being between 0 and 15%.

Mention may be made by way of example of PA-6, 10 (hexamethylenediamine and sebacic acid units), PA-6, 12 (hexamethylenediamine and dodecanedioic acid units), PA-6, 14 (hexamethylenediamine and C14 diacide), PA-6, 18 (hexamethylenediamine and C18 diacide) and PA-10, 10 (1,10-decane diamine and sebacic acid units).

Mention may also be made of polyamides of formula X/Y,Ar in which:
Y denotes the residues of an aliphatic diamine having from 8 to 20 carbon atoms;
Ar denotes the residues of an aromatic dicarboxycylic acid;
X denotes either the residues of aminoundecanoic acid NH₂—(CH₂)₁₀—COOH, of lactam 12 or of the corresponding amino acid, or the unit Y,x remains from the condensation of the diamine with an aliphatic diacid (x) having between 8 and 20 carbon atoms or else the unit Y, I remains from the condensation of the diamine with isophthalic acid.

### X/Y,Ar Denotes, for Example:

11/10,T, which results from the condensation of aminoundecanoic acid, 1,10-decanediamine and terephthalic acid;
12/12,T, which results from the condensation of lactam 12, 1,12-dodecanediamine and terephthalic acid;
10,10/10,T, which results from the condensation of sebacic acid, 1,10-decanediamine and terephthalic acid; and
10,I/10,T, which results from the condensation of isophthalic acid, 1,10-decanediamine and terephthalic acid.

The inherent viscosity of the polyamide of the outer layer (1) may be between 1 and 2 and advantageously between 1.2 and 1.8. The inherent viscosity is measured at 20° C. for a 0.5% concentration in metacresol. The polyamide of the outer layer (1) may contain from 0 to 30% by weight of at least one product chosen from plasticizers and impact modifiers per 100 to 70% of polyamide respectively. This polyamide may contain the usual additives, such as UV stabilizers, thermal stabilizers, antioxidants, fire retardants, etc.

With regard to blend (A) and firstly the polyethylene carrying epoxy functional groups, this may be a polyethylene onto which epoxy functional groups have been grafted or an ethylene/unsaturated epoxide copolymer.

With regard to ethylene/unsaturated epoxide copolymers, mention may be made, for example, of copolymers of ethylene with an alkyle (meth)acrylate and with an unsaturated epoxide, or copolymers of ethylene with a vinyl ester of a saturated carboxylic acid and with an unsaturated epoxide. The amount of epoxide may be up to 15% by weight of the copolymer and the amount of ethylene at least 50% by weight. Advantageously, the proportion of epoxide is between 2 and 12% by weight. Advantageously, the proportion of alkyl (meth)acrylate is between 0 and 40% by weight and preferably between 5 and 35% by weight.

Advantageously, this is an ethylene/alkyl (meth)acrylate/unsaturated epoxide copolymer.

Preferably, the alkyl (meth)acrylate is such that the alkyl possesses 1 to 10 carbon atoms.

The MFI (melt flow index) may for example be between 0.1 and 50 g/10 min (190° C./2.16 kg).

Examples of alkyl acrylates and methacrylates that can be used are especially methyl methacrylate, methyl acrylate, ethyl acrylate, n-butyl acrylate, isobutyl acrylate and 2-ethylexyl acrylate. Examples of unsaturated epoxides that can be used are especially:

aliphatic glycidyl esters and ethers, such as allyl glycidyl ether, vinyl glycidyl ether, glycidyl maleate, glycidyl itaconate, glycidyl acrylate and glycidyl methacrylate; and

alicyclic glycidyl esters and ethers, such as 2-cyclohexen-1-yl glycidyl ether, glycidyl cyclohexene-4,5-dicarboxylate, glycidyl cyclohexene-4-carboxylate, glycidyl 2-methyl-5-norbornene-2-carboxylate and glycidyl endo-cis-bicyclo 2.2.1]hept-5-ene-2,3-dicarboxylate.

With regard to blend (A) and now the impact modifier, and firstly elastomers, mention may be made of SBS, SIS and SEBS block polymers and ethylene-propylene (EPR) or ethylene-propylene-diene monomer (EPDM) elastomers. As regards the very-low density polyethylenes, these are, for example, metallocene polyethylenes of density between for example 0.860 and 0.900. Acrylic elastomers are not recommended as they cause permeability to the petrol. The term “acrylic elastomers” denotes elastomers based on at least one monomer chosen from acrylonitrile, alkyl (meth)acrylates and core/shell copolymers. As regards core/shell copolymers, these are in the form of fine particles having an elastomer core and at least one thermoplastic shell (usually PMMA), the size of the particles generally being less than 1 μm and advantageously between 50 and 300 nm. It would not be outside the scope of the invention to use these acrylic elastomers, but this would be to the detriment of the permeability to the petrol. For example, 1 to 3 parts of acrylic elastomers per 5 to 10 parts of other impact modifiers may be used. Advantageously, an ethylene-propylene (EPR) or ethylene-propylene-diene monomer (EPDM) elastomer is used. The functionalization may be provided by grafting or copolymerizing with an unsaturated carboxylic acid. It would not be outside the scope of the invention to use a functional derivative of this acid. Examples of unsaturated carboxylic acids are those having 2 to 20 carbon atoms, such as acrylic, methacrylic, maleic, fumaric and itaconic acids. The functional derivatives of these acids comprise, for example, anhydrides, ester derivatives, amide derivatives, imide derivatives and metal salts (such as alkali metal salts) of unsaturated carboxylic acids.

Unsaturated dicarboxylic acids having 4 to 10 carbon atoms and their functional derivatives, particularly their anhydrides, are particularly preferred grafting monomers. These grafting monomers comprise, for example, maleic, fumaric, itaconic, citraconic, allylsuccinic, cyclohex-4-ene-1,2-dicarboxylic, 4-methylcyclohex-4-ene-1,2-dicarboxylic, bicyclo[2.2.1]hept-5-ene-2,3-dicarboxylic and x-methylbicyclo[2.2.1]hept-5-ene-2,3-dicarboxylic acids and maleic, itaconic, citraconic, allylsuccinic, cyclohex-4-ene-1,2-dicarboxylic, 4-methylenecyclohex-4-ene-1,2-dicarboxylic, bicyclo-[2.2.1]hept-5-ene-2,3-dicarboxylic and x-methyl-bicyclo[2.2.1]hept-5-ene-2,2-dicarboxylic anhydrides. Advantageously, maleic anhydride is used.

Various known processes may be used to graft a grafting monomer onto a polymer. For example, this may be carried out by heating the polymers to a high temperature, about 150 to about 300° C., in the presence or absence of a solvent and with or without a radical initiator. The amount of grafting monomer may be chosen appropriately, but it is preferably from 0.01 to 10%, better still from 600 ppm to 2%, with respect to the weight of the polymer onto which the graft is attached.

As regards the functionalized fluoropolymer (B2) and firstly the fluoropolymer, this denotes any polymer having in its chain at least one monomer chosen from compounds that contain a vinyl group capable of opening in order to be polymerized and that contains, directly attached to this vinyl group, at least one fluorine atom, a fluoroalkyl group or a fluoroalkoxy group.

As examples of monomers, mention may be made of vinyl fluoride; vinylidene fluoride (VDF); trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers, such as perfluoro(methyl vinyl)ether (PMVE), perfluoro(ethyl vinyl)ether (PEVE) and perfluoro(propyl vinyl)ether (PPVE).

The fluoropolymer may be a homopolymer or a copolymer; it may also include non-fluorinated monomers such as ethylene.

As examples, the fluoropolymer is chosen from:

homopolymers and copolymers of vinylidene fluoride (VDF) preferably containing, by weight, at least 50% VDF, the copolymer being chosen from chlorotrifluoro-ethylene (CTFE), hexafluoropropylene (HFP), trifluoro-ethylene (VF3) and tetrafluoroethylene (TFE);

homopolymers and copolymers of trifluoroethylene (VF3); and

copolymers, and especially terpolymers, combining the residues of chlorotrifluoroethylene (CTFE), tetrafluoroethylene (TFE), hexafluoropropylene (HFP) and/or ethylene units and optionally VDF and/or VF3 units.

mention may also be made of ethylene/tetrafluoroethylene (ETFE) copolymers.

Advantageously, the fluoropolymer is a poly(vinylidene fluoride) (PVDF) homopolymer or copolymer. Preferably, the PVDF contains, by weight, at least 50%, more preferably at least 75% and better still at least 85% VDF. The comonomer is advantageously HFP. Advantageously, the PVDF has a viscosity ranging from 100 Pa·s to 2000 Pa·s, the viscosity being measured at 230° C. and a shear rate of 100 s⁻¹ using a capillary rheometer. These PVDFs are well-suited to extrusion and to injection moulding. Preferably, the PVDF has a viscosity ranging from 300 Pa·s to 1200 Pa·s, the viscosity being measured at 230° C. with a shear rate of 100 s⁻¹ using a capillary rheometer. By way of example of functionalized fluoropolymer mention may be made of functionalized PVDF, that is a PVDF comprising monomer units of VDF and of at least one functional monomer having a least one functional group that may be one of the following groups: a carboxylic acid, a carboxylic acid salt, a carbonate, a carboxylic acid anhydride, an epoxide, a carboxylic acid ester, a silyl, an alkoxysilane, a carboxylic amide, a hydroxyl, an isocyanate. The functionalized PVDF is prepared in suspension, in emulsion or in solution by copolymerizing VDF with said at least one functional monomer and optionally at least another comonomer.

By way of example of a functionalized fluoropolymer, mention may be made of that grafted with an unsaturated monomer. It may be produced according to a grafting process in which:

a) the fluoropolymer is melt-blended with the unsaturated monomer;

b) the blend obtained in a) is made in the form of films, sheets, granules or powder;

c) the products from step b) are subjected, in the absence of air, advantageously to photon (γ) or electron (β) irradiation with a dose of between 1 and 15 Mrad; and

d) the product obtained in c) is optionally treated in order to remove all or part of the unsaturated monomer that has not been grafted onto the fluoropolymer.

As examples of unsaturated grafting monomers, mention may be made of carboxylic acid and their derivatives, acid chlorides, isocyanates, oxazolines, epoxydes, amines and hydroxides. Examples of unsaturated carboxylic acids are those having 2 to 20 carbon atoms such as acrylic, methacrylic, maleic, fumaric and itaconic acids. The functional derivatives of these acids comprise, for example, anhydrides, ester derivatives, amide derivatives, imide derivatives and metal salts (such as alkali metal salts) of unsaturated carboxylic acids. Mention may also be made of undecylenic acid and zinc undecylenate.

Unsaturated dicarboxylic acids having 4 to 10 carbon atoms and their functional derivatives, particularly their anhydrides, are particularly preferred grafting monomers.

Step a) is carried out in any blending device, such as extruders or mixers used in the thermoplastics industry.

With regard to the proportions of the fluoropolymer and of the unsaturated monomer, the proportion of fluoropolymer is advantageously, by weight, from 90 to 99.9% per 0.1 to 10% of unsaturated monomer respectively. Preferably, the proportion of fluoropolymer is from 95 to 99.9% per 0.1 to 5% of unsaturated monomer respectively.

After step a) it has been found that the fluoropolymer/unsaturated monomer blend has lost about 10 to 50% of the unsaturated monomer that had been introduced at the start of step a).

This proportion depends on the volatility and the nature of the unsaturated monomer. In fact, the monomer has been vented in the extruder or the mixer and it is recovered in the venting circuits.

With regard to step c), the products recovered after step b) are advantageously packaged in polyethylene bags and the air expelled, the bags then being sealed. During this grafting step, it is preferable to avoid the presence of oxygen. Flushing the fluoropolymer/graftable compound blend with nitrogen or argon is therefore possible in order to eliminate the oxygen.

As regards the method of irradiation, it is possible to use, without distinction, electron irradiation, better known as beta irradiation, and photon irradiation, better known as gamma irradiation. Advantageously, the dose between 2 and 6 Mrad and preferably between 3 and 5 Mrad. This results in the unsaturated monomer being grafted to an amount of 0.1 to 5 wt % (that is to say the grafted unsaturated monomer corresponds to 0.1 to 5 parts per 99.9 to 95 parts of fluoropolymer), advantageously 0.5 to 5 wt % and preferably 0.5 to 1.5 wt %; better still 0.7 to 1.5 wt %; better still 0.8 to 1.5 wt %; better still 0.9 to 1.5 wt %; better still 1 to 1.5 wt %. The grafted unsaturated monomer content depends on the initial content of the unsaturated monomer in the fluoropolymer/unsaturated monomer blend to be irradiated. It also depends on the grafting efficiency, and therefore on the duration and the energy of the irradiation.

With regard to step d), any ungrafted monomer and the residues liberated by the grafting, especially HF can be eliminated by any means. The proportion of grafted monomer relative to the monomer present at the start of step c) is between 50 and 100%. It is possible to wash with solvents that are inert with respect to the fluoropolymer and to the grafted functional groups. For example, when maleic anhydride is grafted, it is possible to wash with chlorobenzene. It is also possible, more simply, to vacuum degas the product recovered at step c), while optionally heating at the same time. This operation may be carried out using techniques known to those skilled in the art. It is also possible to dissolve the modified fluoropolymer in a suitable solvent, such as for example N-methyl pyrrolidone, and then to precipitate the polymer in a non-solvent, for example in water or in an alcohol.

As an example of a functionalized fluoropolymer, mention may also be made of one that is grafted with an unsaturated monomer, but via a radical route. The unsaturated monomer may be chosen from those mentioned above. This method is less effective than radiation grafting—it is possible to graft no more than 0.8% of unsaturated monomer and there is a risk of degrading the fluoropolymer. However, this product may be suitable for simple operating conditions.

One of the advantages of this radiation grafting process is that it is possible to obtain higher grafted unsaturated monomer contents than with conventional grafting processes using a radical initiator. Thus, typically, with the radiation grafting process, it is possible to obtain contents of greater than 1% (one part of unsaturated monomer per 99 parts of fluoropolymer), or even greater than 1.5%, whereas with a conventional grafting process carried out in an extruder, the content is around 0.2 to 0.8%. Moreover, the radiation grafting takes place “cold”, typically at temperatures below 100° C., or even below 70° C., so that the fluoropolymer/unsaturated monomer blend is not in the melt state, as in the case of a conventional grafting process carried out in an extruder. One essential difference is therefore that, in the case of a semicrystalline fluoropolymer (as is the case with PVDF for example) the grafting takes place in the amorphous phase and not in the crystalline phase, whereas homogeneous grafting is produced in the case of grafting carried out in an extruder. The unsaturated monomer is therefore not distributed along the fluoropolymer chains in the same way in the case of radiation grafting as in the case of grafting carried out in an extruder. The modified fluoropolymer therefore has a different distribution of the graftable compound along the fluoropolymer chains compared with a product obtained by grafting carried out in an extruder.

As examples of functionalized fluoropolymers, mention may also be made of those in which a functional monomer or an element carrying a functional group has been incorporated during the polymerization. By way of example such incorporation comes from the chain transfer agent. Such functionalized fluoropolymers are disclosed in U.S. Pat. No. 5,415,958, U.S. Pat. No. 6,680,124 and U.S. Pat. No. 6,703,465 and patent application US 2004-0191440, the contents of which are incorporated into the present application.

With regard to the fluoropolymer (B1), this may be chosen from the same polymers as (B2). (B1) may be the same polymer as (B2), but not functionalized, or it may be different.

With regard to the embodiment in which the inner layer (2) or (2a) is in contact with the transported fluid and more particularly the proportions, those of (A) are advantageously from 5 to 10% per 95 to 90% of (B) respectively. The proportion of the polyethylene carrying epoxy functional groups may be from 1 to 2 parts per 5 parts of impact modifier. The proportion of (B2) is advantageously between 35 and 60%, preferably between 45 and 55%, by weight of (A)+(B).

With regard to the preparation of the compositions of the invention, these may be obtained by melt-blending of the constituents using standard techniques for thermoplastics.

The (A)/(B) blends may furthermore contain at least one additive chosen from:

dyes;

pigments;

antioxidants;

fire retardants;

UV stabilizers;

nanofillers;

nucleating agents.

With regard to the inner layer (2) containing an electrically conductive material, mention may be made, as examples of electrically conductive material, of carbon black, carbon fibres and carbon nanotubes. It is advantageous to use a carbon black chosen from those having a BET specific surface area, measured according to the ASTM D3037-89 standard, of 5 to 200 m²/g and DBP absorption, measured according to the ASTM D 2414-90 standard, of 50 to 300 ml/100 g. The proportion of black is advantageously, by weight, from 10 to 30% per 90 to 70% of the other constituents respectively, and preferably from 12 to 23% per 88 to 77% of the other constituents respectively. These carbon blacks are described in Patent Application WO 99/33908, the contents of which are incorporated in the present application.

With regard to the inner layer (2a) containing an electrically conductive material, this layer, like the layer (2) may consist of the blend of (A) and (B) and contains the electrically conductive material. The proportions of (A) and (B) and the nature of the constituents of (A) and (B) may be the same as or different from those of the layer (2). It may also be a fluoropolymer (B1) or a blend of a fluoropolymer (B1) and an impact modifier and contains, in addition, an electrically conductive material producing a surface resistivity of preferably less than 10⁶Ω. The impact modifier may be chosen from those mentioned for the blend (A), including acrylic elastomers. It may consist entirely of acrylic elastomers (preferably core/shell elastomers), since this layer does not need to be a barrier to petrol, this function being provided by the layer (2). If the impact modifier is not an acrylic elastomer or is a blend of an acrylic elastomer with, for example, an EPR, this EPR is advantageously functionalized. To make compatibilization with (B1) easier, it is recommended to add some functionalized polymer (B2). The fluoropolymer (B1) may be the same as that of the layer (2) or be different. It is also possible to add some functionalized fluoropolymer (B2), which may be the same as that of the layer (2) or be different. Advantageously, (B1) and (B2) are PVDF homopolymers or copolymers. The proportion of black by weight is advantageously from 10 to 30% per 90 to 70% of the other constituents respectively, and preferably from 12 to 23% per 88 to 77% of the other constituents respectively. The proportion of impact modifier is advantageously from 1 to 40% by weight of the combination of impact modifier, fluoropolymer (B1) and optional fluoropolymer (B2). Preferably, this proportion is from 5 to 35% by weight of the combination of impact modifier, fluoropolymer (B1) and optional fluoropolymer (B2).

With regard to the embodiment in which the tube includes an inner layer (3), the polyamide of the outer layer (1) may be chosen from the polyamides of the outer layer (1) described above.

With regard to the layer (2), the nature of the constituents (A) and (B) is the same as that described above. The proportions of (A) are advantageously from 5 to 30% per 95 to 70% of (B) respectively. The proportions of (A) are preferably from 5 to 10% per 95 to 90% of (B) respectively. The proportion of polyethylene carrying epoxy functional groups may be between 1 and 2 parts per 5 parts of impact modifier. The proportion of (B2) is advantageously between 35 and 60%, preferably between 45 and 55%, by weight of (A)+(B).

The polyamide of the inner layer (3) may be chosen from the polyamides mentioned in the case of the outer layer, PA-6 and PA-6/polyolefin blends having a PA-6 matrix and a polyolefin dispersed phase.

In the PA-6/polyolefin blends having a PA-6 matrix and a polyolefin dispersed phase, the term “polyolefin” denotes both homopolymers and copolymers, and both thermoplastics and elastomers. These include, for example, ethylene/α-olefin copolymers. These polyolefins may be LLDPEs, PEs, EPRs and EPDMs. They may be partly or completely functionalized. The dispersed phase may be a blend of one or more unfunctionalized polyolefins and one or more functionalized polyolefins. Advantageously, the PA-6 matrix represents, by weight, 50 to 85% per 50 to 15% of dispersed phase respectively. Preferably, the PA-6 matrix represents, by weight, 55 to 80% per 45 to 20% of dispersed phase respectively.

According to a preferred embodiment, the PA-6/polyolefin blends having a PA-6 matrix comprise, the total being 100%:

50 to 90% (advantageously 60 to 80%) of PA-6;

1 to 30% (advantageously 10 to 25%) of HDPE;

5 to 30% (advantageously 10 to 20%) of at least one polymer P1 chosen from impact modifiers and polyethylenes,

at least one of the HDPE and of P1 being completely or partly functionalized.

Advantageously, the impact modifier is chosen from elastomers and very low-density polyethylenes.

With regard to the impact modifier and firstly the elastomers, mention may be made of SBS, SIS, SEBS block copolymers and ethylene-propylene (EPR) and ethylene-propylene-diene monomer (EPDM) elastomers. As regards the very low-density polyethylenes, these are for example metallocene polyethylenes having a density for example between 0.860 and 0.900.

It is advantageous to use an ethylene-propylene (EPR) or ethylene-propylene-diene monomer (EPDM) elastomer. The functionalization may be provided by grafting or copolymerizing with an unsaturated carboxylic acid. It would not be outside the scope of the invention to use a functional derivative of this acid. Examples of unsaturated carboxylic acids are those having 2 to 20 carbon atoms, such as acrylic, methacrylic, maleic, fumaric and itaconic acids. The functional derivatives of these acids comprise, for example, anhydrides, ester derivatives, amide derivatives, imide derivatives and metal salts (such as alkali metal salts) of unsaturated carboxylic acids.

Unsaturated dicarboxylic acids having 4 to 10 carbon atoms and their functional derivatives, particularly their anhydrides, are particularly preferred grafting monomers. It is advantageous to use maleic anhydride.

The proportion of functionalized HDPE and/or functionalized P1 relative to all of the functionalized and unfunctionalized HDPE and functionalized and unfunctionalized P1 may be between 0 and 80%, advantageously between 5 and 70% and preferably between 20 and 70% by weight.

The PA-6/polyolefin blends having a PA-6 matrix may be prepared by melt-blending the various constituents in standard equipment used in the thermoplastic polymer industry.

According to a first embodiment of these PA-6/polyolefin blends having a PA-6 matrix, the HDPE is not grafted and P1 is a grafted elastomer/ungrafted elastomer blend.

According to another embodiment of these PA-6/polyolefin blends having a PA-6 matrix, the HDPE is ungrafted and P1 is a grafted polyethylene, optionally blended with an elastomer.

With regard to the inner layer (3) or (3a) containing an electrically conductive material, mention may be made, as examples of electrically conductive material, of carbon black, carbon fibres and carbon nanotubes. It is advantageous to use a carbon black chosen from those having a BET specific surface area, measured according to the ASTM D3037-89 standard, of 5 to 200 m²/g and DBP absorption, measured according to the ASTM D 2414-90 standard, of 50 to 300 ml/100 g. The proportion of black is advantageously, by weight, from 16 to 30% per 84 to 70% of the other constituents respectively, and preferably from 17 to 23% per 83 to 77% of the other constituents respectively. These carbon blacks are described in Patent Application WO 99/33908, the contents of which are incorporated in the present application.

### EXAMPLES

The following polymers were used:

Kynar® ADX 120: a functional PVDF homopolymer grafted with maleic anhydride, from Arkema, with an MVI (Melt Volume Index) of 7 cm³/10 nm (230° C./5 kg).
Kynar® 740: a PVDF homopolymer from Arkema with an MVI (Melt Volume Index) of 1 cm³/10 mm (230° C./5 kg).
LOTADER® 8840: an ethylene/glycidyl methacrylate copolymer from Arkema with an MVI (Melt Volume Index) of 5 cm³/10 min (190° C./2.16 kg) and containing 92% ethylene and 8% glycidyl methacrylate by weight.
EXXELOR® VA 1803: an EPR elastomer grafted with maleic anhydride, with an MFI of 3 g/10 min (230° C.-2.16 kg).
Rilsan MA4411®: an impact-modified plasticized nylon-12 from Arkema.
Conductive nylon-12: a composition similar to Rilsan MA4411® but containing in addition 20% carbon black (to the detriment of nylon-12).

### Example 1

A Kynar 740 (38 wt %)/Kynar ADX 120 (50 wt %)/LOTADER 8840 (2 wt %)/EXXELOR VA 1803 (10 wt %) blend was produced at 230° C. in a Werner 40-type extruder. This blend, once produced, has a nodular morphology, the mean size of the dispersed phase being less than 5 μm.

A two layer tube 1 mm in thickness and 8 mm in outside diameter, composed of Rilsan MA4411® as external layer (800 μm) and the above PVDF alloy as internal layer (200 μm), was extruded on a McNeil line at 230° C.

The peel force needed to separate the internal layer from the external layer at 50 mm/min was 50 N/cm.

This tube passed the −40° C. impact test according to the SAEJ 2260 standard.

### Example 2

A three-layer tube of 1 mm thickness and 8 mm outside diameter, composed of Rilsan MA4411® as external layer (400 μm), ADX120 as intermediate layer (200 μn) and conductive nylon-12 as internal layer (400 μm), was extruded on a McNeil line at 230° C.

The peel force needed to separate the internal or external layer from the grafted PVDF layer at 50 mm/min was 50 N/cm.

This tube passed the −40° C. impact test according to the SAEJ 2260 standard.

The surface resistivity measured on the tube according to the SAEJ 2260 standard was less than 10⁶ ohms.sq.

This tube had a CE10 permeability at 40° C. of less than 5 g/m²/day (CE10 petrol contains 45% isooctane, 45% toluene and 10% ethanol by volume).

1. Multilayer tube comprising, in its radial direction from the outside inwards:
a polyamide outer layer (1);
an inner layer (2) of a composition comprising, the total being 100%, 5 to 30% by weight of a blend (A) comprising:
a polyethylene carrying epoxy functional groups,
an impact modifier chosen from elastomers and very low-density polyethylenes, the said impact modifier being completely or partly functionalized;
95 to 70% by weight of a blend (B) comprising:
a fluoropolymer (B1),
a functionalized fluoropolymer (B2),
the proportion of (B2) being between 1 and 80% by weight of (A)+(B),
the layers being successive and adhering to one another in their respective contact region.

2. Tube according to claim 1, in which the inner layer (2) contains an electrically conductive material.

3. Tube according to claim 1, in which the inner layer (2) contains essentially no electrically conductive material and the tube comprises a layer (2a) placed beside the layer (2), which layer (2a) is, like the layer (2) based on (A) and (B) but contains, in addition, an electrically conductive material.

4. Tube according to claim 1, in which the inner layer (2) contains essentially no electrically conductive material and the tube comprises a layer (2a) placed beside the layer (2), which layer (2a) is a blend of a fluoropolymer (B1) and an impact modifier, and contains in addition an electrically conductive material producing a surface resistivity of preferably less than 10⁶Ω.

5. Multilayer tube comprising, in its radial direction from the outside inwards:
a polyamide outer layer (1);
a layer (2) of a composition comprising, the total being 100%, 0 to 30% by weight of a blend (A) comprising:
a polyethylene carrying epoxy functional groups,
an impact modifier chosen from elastomers and very low-density
polyethylenes, the said impact modifier being completely or partly functionalized;
100 to 70% by weight of a blend (B) comprising:
optionally, a fluoropolymer (B1),
a functionalized fluoropolymer (B2),
the proportion of (B2) being between 10 and 100% by weight of (A)+(B);
a polyolefin inner layer (3);
the layers being successive and adhering to each other in their respective contact region.

6. Tube according to claim 5, in which the proportions of (A) are from 5 to 30% per 95 to 70% of (B) respectively.

7. Tube according to claim 5, in which the inner layer (3) contains an electrically conductive material.

8. Tube according to claim 5, in which the inner layer (3) contains essentially no electrically conductive material and the tube comprises a layer (3a) placed beside the layer (3), which layer (3a), like the layer (3), is a polyamide layer but also contains an electrically conductive material.

9. Tube according to claim 5, in which the polyamide of the outer layer (1) is a polyamide having amine terminal groups or comprising more amine terminal groups than acid terminal groups.

10. Tube according to claim 5 in which a layer of a polyamide having amine terminal groups or one comprising more amine terminal groups than acid terminal groups is placed between the outer layer (1) and the layer (2).

11. Tube according to claim 5, in which the impact modifier of the blend (A) is an EPR grafted with maleic anhydride or an EPDM grafted with maleic anhydride.

12. Tube according to claim 5, in which the functionalized fluoropolymer (B2) is a PVDF homopolymer or copolymer grafted with maleic anhydride.

13. Tube according to claim 5, in which the fluoropolymer (B1) is a PVDF homopolymer or copolymer.

14. Tube according to claim 6, in which the proportions of (A) are from 5 to 10% per 95 to 90% of (B) respectively.

15. Tube according to claim 5, in which the proportion of the polyethylene carrying epoxy functional groups is from 1 to 2 parts per 5 parts of impact modifier.

16. Tube according to claim 5, in which the proportion of (B2) in the blends of (A) and (B) is between 35 and 60% by weight of (A)+(B).

17. Tube according to claim 16, in which the proportion of (B2) in the blends of (A) and (B) is between 45 and 55% by weight of (A)+(B).

18. Tube according to claim 5 wherein said tube further comprises within the tube and in direct contact with the inner layer of the tube, petrol.

19. The multiplayer tube according to claim 1 wherein the proportion of (B2) being between 1 and 60% by weight of (A)+(B).
